(19) United States
(12) Patent Application Publication
(10) Pub. No.: US 2010/0236080 A1
(43) Pub. Date: Sep. 23, 2010

(54) Wire Cutting Device

(76) Inventor: Hsin-Te Huang, Taichung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/723,736

(22) Filed: Mar. 15, 2010

(30) Foreign Application Priority Data
Mar. 20, 2009 (TW) 98109216

(51) Int. Cl. B23D 17/08; B26B 27/00

(52) U.S. Cl. 30/231; 30/251

(57) ABSTRACT

A wire cutting device includes a base, a fixed blade member mounted on the base, an operation handle including a gripping end adapted to be grasped when operating the wire cutting device and a hinge end pivotally connected to the fixed blade member such that the operation handle is moveable between a first position away from the base and a second position towards the base. The wire cutting device also includes a moving blade mechanism operably controlled by the operation handle. The base can contact with a surface that serves to stably support the wire cutting device, and with the wire cutting device being stably supported by the surface during the operation thereof and thereby making the operation effort-saving.

### BACKGROUND OF THE INVENTION

1. Field of the Invention

The present invention relates to a wire cutting device, and more particularly, to a wire cutting device which is able to be stably positioned on a surface such that the surface stably supports the wire cutting device during the operation thereof.

2. Description of the Related Art

Taiwan Patent No. 492398 discloses a wire cutting device designed to be effort-saving. The wire cutting device includes a pair of cutting members, a lock mechanism, and a pair of levers, and each cutting member includes a cutting edge of a serrated shape in order to enable an object to be cut in an effort-saving manner. Nevertheless, the wire cutting device still encounter some problems. A problem that the wire cutting device suffers is that two hands are required during the operation. Another problem is that it is difficult to exert a relatively large force when one hand is utilized to hold the wire cutting device while the other hand is utilized to exert a force. Additionally, if a user tries to exert a relative large force, his or her hands are liable to slip off the levers.

The present invention is, therefore, intended to obviate or at least alleviate the problems encountered in the prior art.

### SUMMARY OF THE INVENTION

According to the present invention, a wire cutting device includes a base including a first side and a second side, a fixed blade member mounted on the first side of base and including a first connecting portion and a second connecting portion defined thereon, and an operation handle including a gripping end adapted to be grasped when operating the wire cutting device and a hinge end pivotally connected to the second connecting section such that the operation handle is pivotal with respect to the fixed blade member and is moveable between a first position away from the base and a second position towards the base. The wire cutting device also includes a moving blade mechanism including a linkage including a first end connected to the operation handle by an axle such that the linkage is moveable with the operation handle, and a second end including a cutting member disposed thereon and both pivotally connected to the first connecting section such that the linkage and cutting member are pivotal with respect to the fixed blade member and cooperate therewith in order to cut an object to be cut. Additionally, the axle being moveable in response to the pivoting of the operation handle and being shifted away from the cutting member in order to increase a length of leverage for effort-saving purpose.

Furthermore, the second side of base is utilized to contact with a surface that serves to stably support the wire cutting device, and with the wire cutting device being stably supported by the surface during the operation thereof and thereby making the operation effort-saving.

Other objects, advantages, and new features of the present invention will become apparent from the following detailed description of the invention when considered in conjunction with the accompanied drawings.

### BRIEF DESCRIPTION OF THE DRAWINGS

FIG. 1 is a perspective view of a wire cutting device in accordance with the present invention.

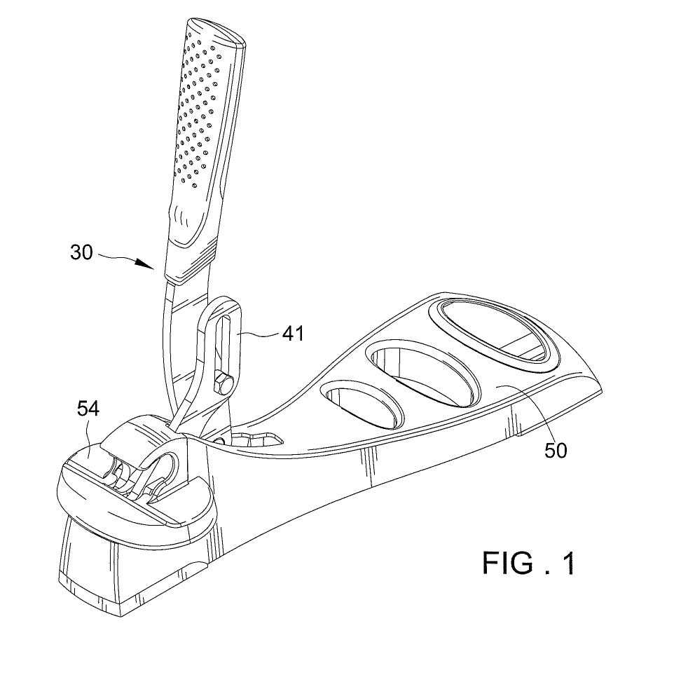

FIG. 2 is a first exploded, perspective view of the wire cutting device shown in FIG. 1.

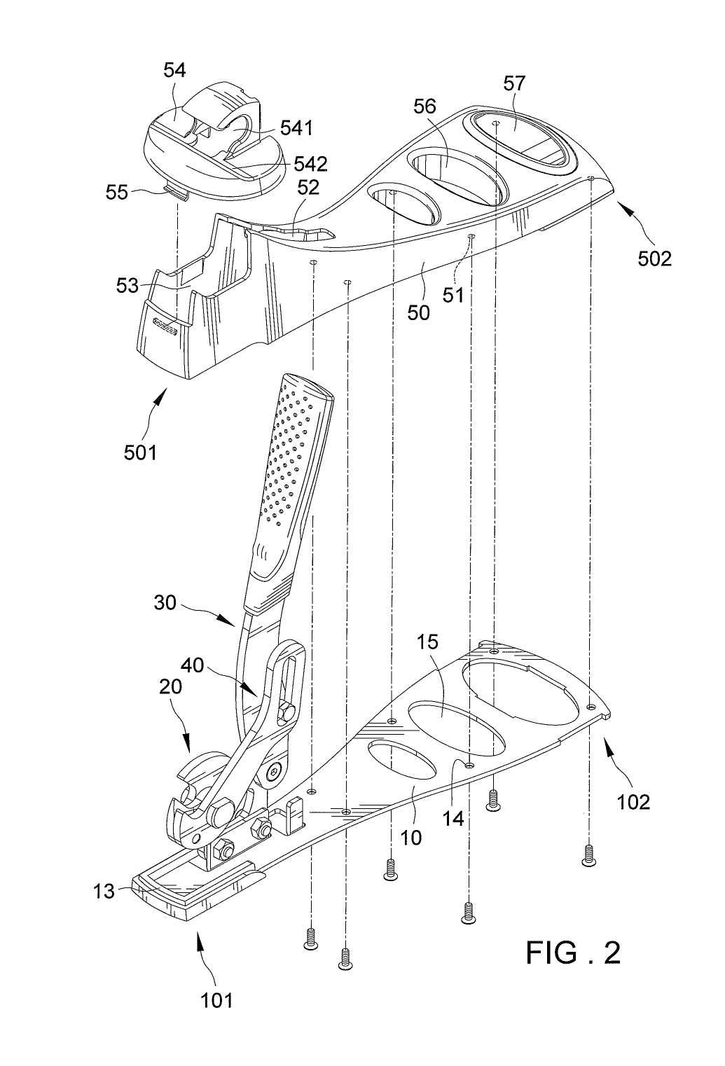

FIG. 3 is a second exploded, perspective view of the wire cutting device shown in FIG. 1.

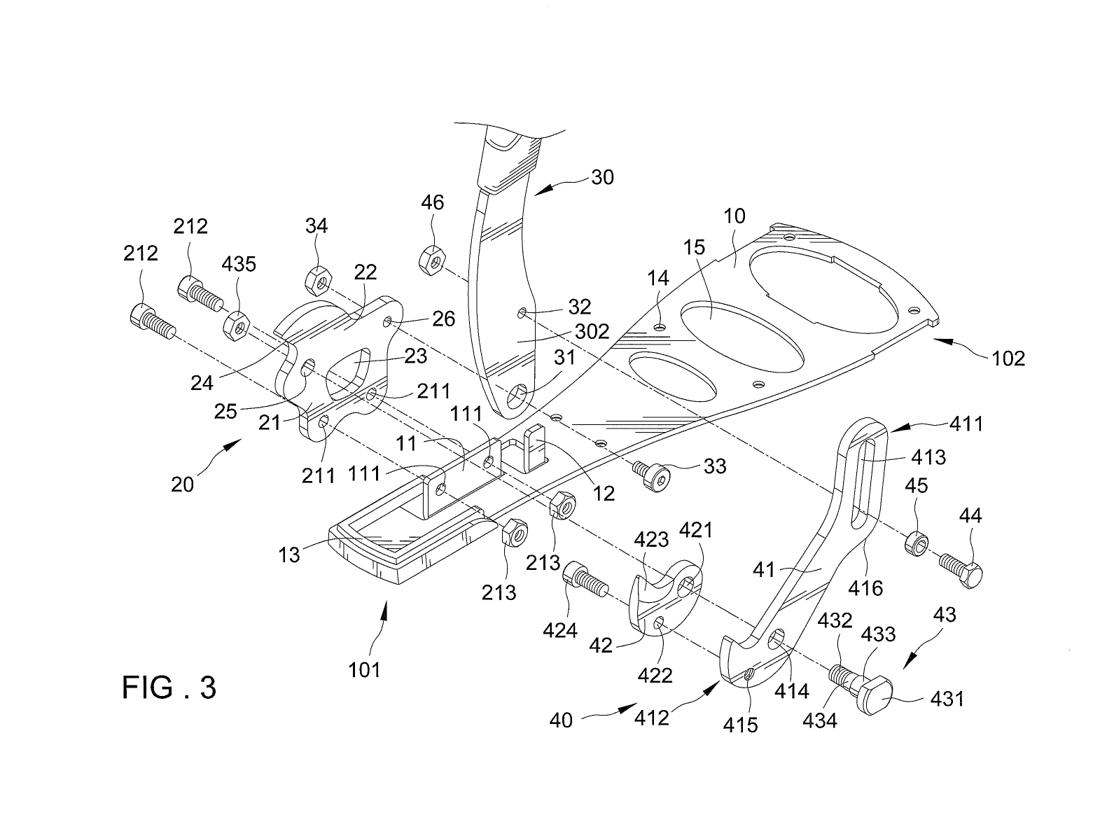

FIG. 4 is a cross-sectional view of the wire cutting device shown in FIG. 1 and shows a wire to be cut disposed on the cutting device, and with the wire shown in phantom.

FIG. 5 is an extended cross-sectional view of FIG. 4 and shows the wire cutting device cutting the wire.

FIG. 6 is an extended cross-sectional view of FIG. 5 and shows the wire cutting device cutting the wire.

### DETAILED DESCRIPTION OF THE PREFERRED EMBODIMENT

Referring to the drawings, a wire cutting device in accordance with the present invention includes a base 10 for enabling it to be operated on a surface, and with the surface stably supporting the wire cutting device during the operation thereof, thereby the cutting device is adapted to be operated by one hand.

The base 10 includes a first end 101 and a second end 102 and has a longitudinal length extending from the first 101 to second 102 ends. The base 10 also includes two opposing sides, i.e. a first side and a second side opposing to the first side, and a connecting section 11 and a stop 12 extending in the same direction from the first side and transversely to the longitudinal length thereof. Furthermore, the connecting section 11 and stop 12 are disposed in proximity to the one of the first 101 and second 102 ends. In the embodiment, the connecting section 11 and stop 12 are disposed in proximity to the first end 101. The base 10 further includes a locking section 13 and a plurality of apertures 14, and a plurality of receptacles 15 defined thereon. Further, a covering apparatus 50, which is used for preventing users from hazards by elements mounted on the base 10 and for an aesthetic reason, is secured to the base 10 via the locking section 13 and a plurality of fasteners (not numbered) extending through the plurality of apertures 14 and engaging in a plurality of apertures 51 defined thereon, respectively. The covering apparatus 50 includes a first end 501 and a second end 502 and is substantially of the same cross-sectional size with the first side of the base 10. In addition, the first end 501 of covering apparatus 50 is connected to the first end 101 of the base 10 while the second end 502 is connected to the second end 102.

The wire cutting device further includes a fixed blade member 20 mounted on the base 10. The fixed blade member 20 includes two opposing lateral sides, i.e. a first lateral side and a second lateral side opposing to the first lateral side, and a peripheral side extending transversely to and joining the first and second lateral sides. The fixed blade member 20 includes a mounting end 21 defined thereon and connected to the connecting section 11 of base 10 such that the fixed blade member 20 is mounted on the base 10. The mounting end 21 has a first side defined from the first lateral side of fixed blade member 20, and the first side is in contact with the connecting section 11 after the fixed blade member 20 is mounted on the base 10, and has a second side defined from the second lateral side. In the embodiment, two fasteners 212 are inserted through two orifices 211 defined on the mounting end 21 and engage in two orifices 111 defined on the connecting section 11, respectively, and each fastener 212 also extends through the connecting section 11 and engages with a securing member 213 such that the securing member 213 prevents the fastener 212 from disengaging from the fixed blade member 20 and connecting section 11. The fixed blade member 20 also includes a connecting end 22 having a first side defined from the first lateral side of fixed blade member 20 and a second side defined from the second lateral side, a cutout 23 extending through the first and second lateral sides so as to save material and weight thereof, and a cutting edge 24 defined from a portion of the peripheral side thereof and including an arcuate shape that is adapted to allow a wire to be accommodated. In addition, the connecting end 22 includes a first connecting portion 25 and a second connecting portion 26 defined thereon, and the first connecting portion 25 is disposed in proximity to the cutting edge 24 while the second connecting portion 26 is disposed distal to the cutting edge 24.

The wire cutting device further includes an operation handle 30 and a moving blade mechanism 40 operably controlled by the operation handle 30. The operation handle 30 includes a first end defining a gripping end 301 such that the gripping end 301 can be grasped when operating the wire cutting device to cut a wire, and a second end defining a hinge end 302, which is pivotally connected to the second connecting section 26 of fixed blade member 20 by a pivot 33 such that the operation handle 30 is pivotal with respect to the fixed blade member 20 and is moveable between a first position away from the base 10 and a second position towards the base 10. The pivot 33 is inserted through a hole 31 defined on the hinge end 302 and engages in the second connecting portion 26, and also extends through the second connecting section 11 and engages with a securing member 34 such that the securing member 34 prevents the fastener 33 from disengaging from the operation handle 30 and fixed blade member 20. The moving blade mechanism 40 includes a linkage 41 including two opposing lateral sides, i.e. a first lateral side and a second lateral side opposing to the first lateral side, and a peripheral side extending transversely to and joining the first and second lateral sides, and a first end 411 connected to the hinge end 302 of operation handle 30 such that the linkage 41 is moveable with the operation handle 30, and a second end 412 pivotally connected to the first connecting section 25 of fixed blade member 20 such that the linkage 41 is pivotal with respect to the fixed blade member 20. In addition, the linkage 41 includes an abutting portion 416 defined on the peripheral side thereof and which can abut against the stop 12 on the base 10 to stop the operation handle 30 being pivoted further towards the base 10.

The first end 411 of linkage 41 is connected to the operation handle 30 by an axle 44. The axle 44 is inserted into a slot 413 defined on the first end 411 of linkage 41 and engages in an orifice 32 defined on the hinge end 302, and also extends through the hinge end 302 and engages with a securing member 46 such that the securing member 46 prevents the axle 44 from disengaging from the operation handle 30 and moving blade mechanism 40. Additionally, the axle 44 would shift its positions in the slot 413 in response to the pivoting of the operation handle 30. Preferably, the operation handle 30 is pivotally moved in a plane, which is transverse to a longitudinal direction of the axle 44. Furthermore, the axle 44 includes a roller 45 mounted thereon that facilitates a relative movement between the operation handle 30 and moving blade mechanism 40.

The moving blade mechanism 40 further includes a cutting member 42 disposed on the second end 412 of linkage 41 and pivotally connected to the first connecting section 25 of fixed blade member 20. In the embodiment, a fastener 424 is inserted through an orifice 422 defined on the cutting member 42 and engages in an orifice 415, and also extends through the cutting member 42. The cutting member 42 includes two opposing lateral sides, i.e. a first lateral side and a second lateral side opposing to the first lateral side, and a peripheral side extending transversely to and joining the first and second lateral sides. The cutting member 42 also includes a cutting edge 423 defined on the peripheral side thereof and which can cooperate with the cutting edge 24 of fixed blade member 20 such that a wire held between the cutting edges 24 and 423 is prone to be cut as the cutting edge 423 is moved closer toward the cutting edge 24.

The second end 412 of linkage 41 and the cutting member 42 are pivotally connected to the first connecting section 25 of fixed blade member 20 by a pivot 43. The pivot 43 includes a body inserted through a hole 414 defined on the second end 412 of linkage 41 and a hole 421 defined on the cutting member 42 and engages in the first connecting portion 25 of fixed blade member 20, and also extends through the linkage 41, cutting member 42 and first connecting portion 25 and engages with a securing member 435 such that the securing member 435 prevents the pivot 43 from disengaging from the fixed blade member 20 and moving blade mechanism 40. The pivot 43 also includes a head 431 of a size greater than the holes 414 and 421 and disposed at a distal end of the body, so the head 431 is disposed outside the holes 414 and 421 and serves to retain the linkage 41 and cutting member 42. Furthermore, the body of pivot 43 includes a first length defining a first receiving section 433 and a second length defining a second receiving section 434, and the linkage 41, i.e. the second end 412 of linkage 41, and cutting member 42 are supported by the first receiving section 433 while the fixed blade member 20 is supported by the second receiving section 434. Additionally, the first 433 and second 434 receiving sections are adjacent to each other and are of different diametrical length. In the embodiment, the second receiving section 434 is of a smaller diametrical length, so that the fixed blade member 20 is stopped from shifting from the second receiving section 434 to first receiving section 433 by a wall extending between a diametrical length difference therebetween. In addition, the pivot 43 includes a securing end 432 disposed at a distal end of the body and opposite to the head 431 for engaging with the securing member 435.

Furthermore, the covering apparatus 50 set forth includes a first opening 52 through which the gripping end 301 of operation handle 30 can be disposed outside in order to be grasped, a second opening 53 adjacent to the first opening 52 and disposed corresponding to the fixed blade member 20 and cutting member 42, a receiving seat 54 disposed above the second opening 53 and including a latch 55 for keeping it in position, a receiving cavity 541 into which a wire to be cut is disposed, and a guiding edge 542, which is preferably slopped, serves to facilitate positioning of a wire into the receiving cavity 541. Moreover, the covering apparatus 50 includes a plurality of receptacles 56 disposed corresponding to the receptacles 15 of base 10, respectively, and at least one lid 57 received in one of the receptacles 56 to cover an opening of this specific receptacle 56. The at least one lid 57 is secured by latching to the base 10. Additionally, the at least one lid 57 is used to bear an indicia thereon, such as a logo, a trademark or other informative indications and so on.

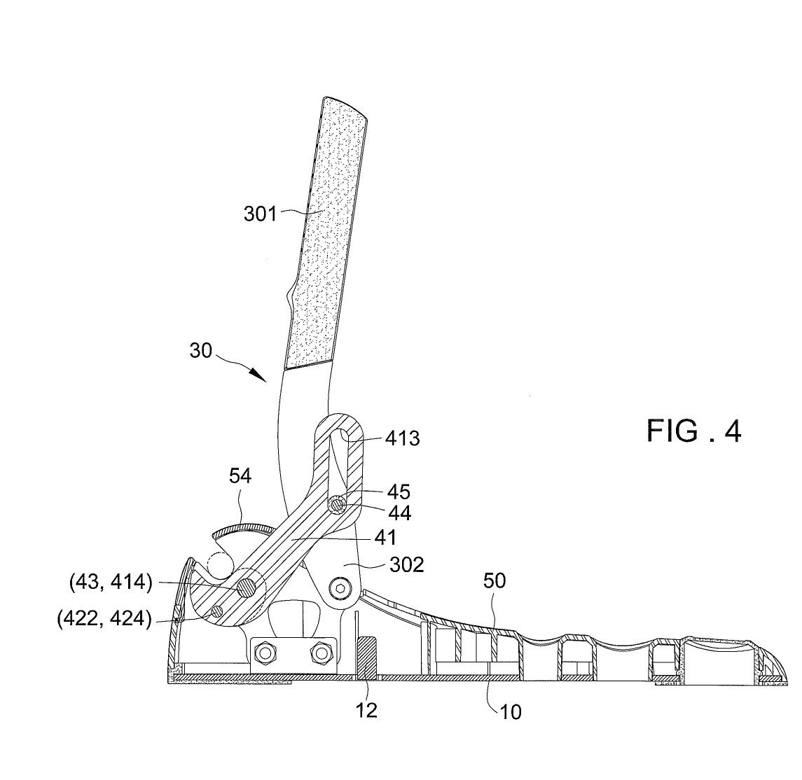

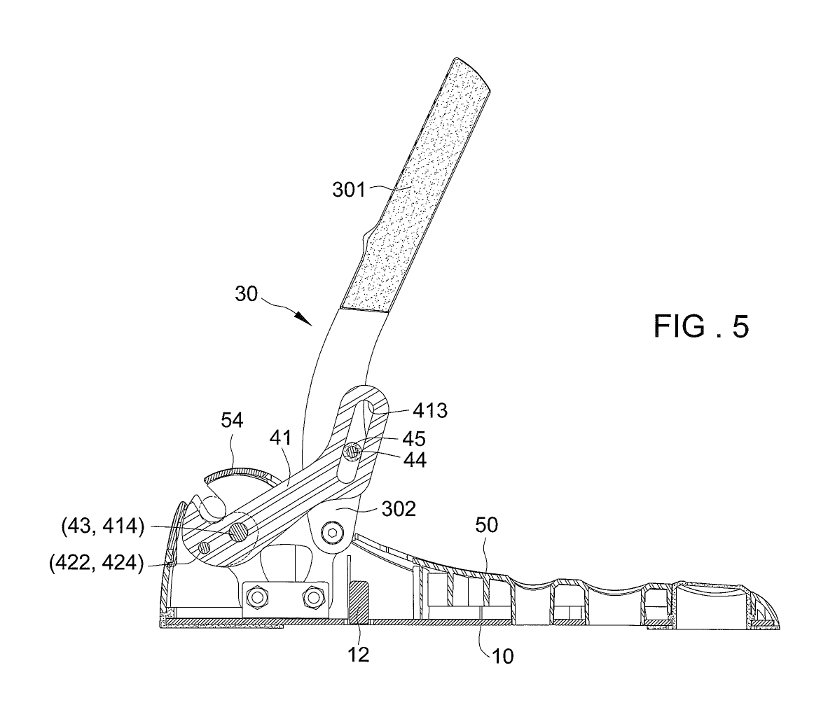

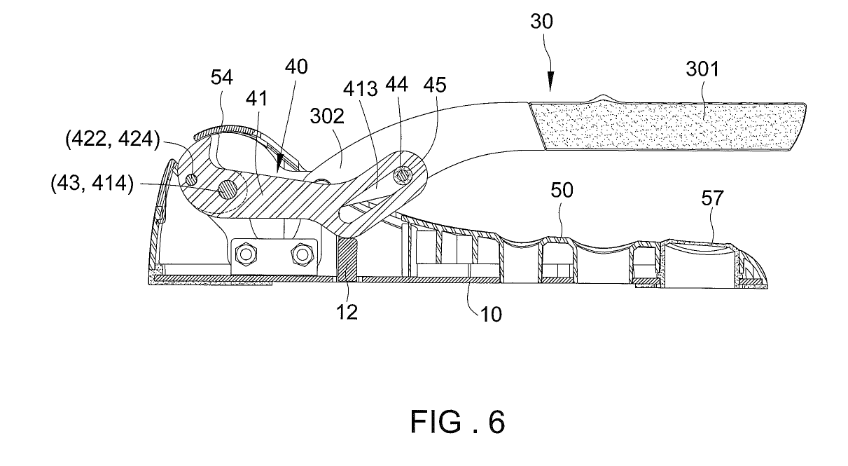

Referring to FIGS. 4 through 6, when the operation handle 30 is pivoted with respect to the fixed blade member 20 and is moved from the first position, i.e. away from the base 10, to the second position, i.e. towards the base 10, to cut a wire disposed on the wire cutting device, the axle 44 is shifted in the slot 413 from a position which is close to the cutting member 42 as in the first position of the operation handle 30 to a position which is away from the cutting member 42 as in the second position of the operation handle 30 so as to increase a length of leverage that a force is applied to cut the wire through the operation handle 30 in an effort-saving manner.

In view of forgoing, it is an object of the present invention that the wire cutting device is able to be operated on a surface, and with the surface stably supporting the wire cutting device during the operation, and thereby making the operation effort-saving.

It is another object of the present invention that the wire cutting device enables a length of leverage for a force, that is applied to cut the wire through the operation handle 30, to increase through shifting the axle 44 away from the cutting member 42.

While the specific embodiments have been illustrated and described, numerous modifications come to mind without significantly departing from the spirit of invention, and the scope of invention is only limited by the scope of the accompanying claims.

What is claimed is:

1. A wire cutting device comprising:
a base including a first side and a second side; and
a fixed blade member mounted on the first side of base and including a first connecting portion and a second connecting portion defined thereon;
an operation handle including a gripping end adapted to be grasped when operating the wire cutting device and a hinge end pivotally connected to the second connecting section such that the operation handle is pivotal with respect to the fixed blade member and is moveable between a first position away from the base and a second position towards the base;
a moving blade mechanism including a linkage including a first end connected to the operation handle by an axle such that the linkage is moveable with the operation handle, and a second end including a cutting member disposed thereon and both pivotally connected to the first connecting section such that the linkage and cutting member are pivotal with respect to the fixed blade member and cooperate therewith in order to cut an object to be cut, and with the axle being moveable in response to the pivoting of the operation handle and being shifted away from the cutting member in order to increase a length of leverage for effort-saving purpose; and
wherein the second side of base is utilized to contact with a surface that serves to stably support the wire cutting device, and with the wire cutting device being stably supported by the surface during the operation thereof and thereby making the operation effort-saving.

2. The wire cutting device as claimed in claim 1 further comprising a covering apparatus mounted on the base in order to prevent users from hazards by fixed blade member, operation handle and moving blade mechanism and for an aesthetic reason.

3. The wire cutting device as claimed in claim 2, wherein the covering apparatus includes a first opening through which the gripping end of operation handle is disposed outside in order to be grasped, a second opening adjacent to the first opening and disposed corresponding to the fixed blade member and cutting member, a receiving seat disposed above the second opening and including a receiving cavity into which the object to be cut is disposed, and a guiding edge for facilitating positioning of the object into the receiving cavity.

4. The wire cutting device as claimed in claim 3, wherein the guiding edge is slopped.

5. The wire cutting device as claimed in claim 1, wherein the fixed blade member includes two opposing lateral sides, and a peripheral side extending transversely to and joining the first and second lateral sides, and wherein the fixed blade member includes a cutting edge defined from a portion of the peripheral side thereof and including an arcuate shape that is adapted to allow the object to be accommodated.

6. The wire cutting device as claimed in claim 1, wherein the first end of linkage includes a slot in which the axle is inserted and moveably engaged, and with the axle being moveable in the slot in response to the pivoting of the operation handle.

7. The wire cutting device as claimed in claim 1, wherein the second end of linkage and the cutting member are pivotally connected to the first connecting section of fixed blade member by a pivot, with the pivot including a body inserted through the linkage, cutting member and first connecting section, with the body including a first length defining a first receiving section and a second length defining a second receiving section, and wherein the second end of linkage and cutting member are supported by the first receiving section, and wherein the fixed blade member is supported by the second receiving section.

8. The wire cutting device as claimed in claim 7, wherein the first and second receiving sections are adjacent to each other and are of different diametrical length.

9. The wire cutting device as claimed in claim 8, wherein the diametrical length of second receiving section is smaller than that of the first receiving section, and wherein the fixed blade member is stopped from shifting from the second receiving section to first receiving section by a wall extending between a diametrical length difference therebetween.

10. The wire cutting device as claimed in claim 2, wherein the covering apparatus includes a plurality of receptacles defined thereon, and at least one lid received in one of the receptacles to cover an opening of this specific receptacle.

11. The wire cutting device as claimed in claim 10, wherein the at least one lid is used to bear an indicia thereon.

12. The wire cutting device as claimed in claim 1, wherein the operation handle is pivotally moved in a plane transverse to a longitudinal direction of the axle.

13. The wire cutting device as claimed in claim 1, wherein the wire cutting device is adapted to be operated by one hand under a condition that the base is stably supported by the surface.
